(19) United States
(12) Patent Application Publication
(10) Pub. No.: US 2016/0009232 A1
(43) Pub. Date: Jan. 14, 2016

(54) Power Toolbox, Power Toolbox Accessory Kit, and Related Methods

(71) Applicant: Adam M. Budny, Duncansville, PA (US)

(72) Inventor: Adam M. Budny, Duncansville, PA (US)

(21) Appl. No.: 14/796,577

(22) Filed: Jul. 10, 2015

Related U.S. Application Data
(60) Provisional application No. 62/118,546, filed on Feb. 20, 2015.
(60) Provisional application No. 62/022,848, filed on Jul. 10, 2014.

(51) Int. Cl. B60R 11/06; B25H 5/00; H02M 7/00; B60R 16/03; B60R 16/033; H02M 7/44; B25H 3/02; B60R 9/06

(52) U.S. Cl. CPC B60R 11/06; B25H 3/02; B25H 5/00; B60R 9/065; B60R 16/03; B60R 16/033; H02M 7/44; H02M 7/003; B60R 2011/004

(57) ABSTRACT

A power toolbox which may include a hollow body, comprising a top, a bottom, and a plurality of walls, and a kit for the same. The power toolbox may also include a first lid, wherein the first lid is attached to an outside edge of the top of the hollow body. The toolbox may further include a connection for a power source positioned inside the hollow body, which may be located on at least one of the plurality of walls. Also included in the toolbox is at least one electrical outlet positioned on a surface of the hollow body. Lastly, the toolbox may include at least one light source, wherein the light source is positioned inside the hollow body and is connected to the power source.

A method of retrofitting the power toolbox in a pickup truck is also disclosed.

### CROSS-REFERENCE TO RELATED APPLICATION

This application claims priority to U.S. Provisional Patent Application No. 62/022,848 filed on Jul. 10, 2014, the disclosure of which is hereby incorporated in its entirety by reference, and U.S. Provisional Patent Application No. 62/118,546 filed Feb. 20, 2015, the disclosure of which is hereby incorporated in its entirety by reference.

### BACKGROUND OF THE INVENTION

1. Field of the Invention

The present disclosure is directed to a toolbox, more specifically, to a modified power toolbox with pre-installed functional features, which may be used in a pickup truck bed.

2. Description of Related Art

Toolboxes, such as those used with and sometimes installed in pickup trucks, provide a place to store tools, equipment, materials, and also provide a dry place to lock things and protect them from theft. Examples of presently existing truck toolboxes are those that can be found commercially from any number of manufacturers or retailers, such as the toolboxes located at the following, which are hereby incorporated by reference in their entirety:
http://www.deezee.com/products/c3112/Crossover_Truck_Tool_Boxes.html;
http://www.homedepot.com/b/Tools-Hardware-Tool-Storage-Truck- Boxes/N-5ye1vZc231;
http://www.lowes.com/Automotive/Truck-Tool-Boxes/_/N-lz0wcmy/pl#!;
http://www.tractorsupply.com/en/store/tractor-supply-coreg%3B-deep-low-profile-black-push-button-tool-box.

Toolboxes, especially pickup truck toolboxes, often do not provide much function for the user other than just being a box with a lid. Therefore, there exists a need for a toolbox, such as a pickup truck toolbox, that is more functional for the user, such as including auxiliary lighting, power outlets, and tie-downs that are pre-installed and integral with the toolbox. Such a toolbox would address a number of the shortcomings found with commercially available toolboxes.

Additionally, in some applications, especially in the field of pickup truck toolboxes, it is undesirable to replace a toolbox entirely. Accordingly, there exists a need to facilitate the incorporation of such additional functionality into existing toolboxes.

### SUMMARY OF THE INVENTION

An embodiment of a toolbox for use in a pickup truck bed may include a hollow body, a lid, a connection for a power source positioned inside the hollow body, at least one electrical outlet positioned on a surface of the hollow body, and a light source. One embodiment of the toolbox further comprises a second lid attached to the inside edge of the top of the hollow body. Another embodiment of the toolbox further comprises a rubberized pad positioned on the bottom of the hollow body.

In accordance with another embodiment of the toolbox, a wiring harness may be connected to a motor vehicle fuse box, wherein the wiring harness passes under a pickup truck body laterally to the pickup truck bed, and then horizontally traveling through the truck bed, through a drill hole located in the back of the toolbox, through a conduit positioned inside the hollow body, and connecting to a toolbox fuse box positioned inside the hollow body. Another embodiment may further include a power inverter positioned inside the hollow body, wherein the power invertor converts DC power to AC power and receives power from a motor vehicle alternator, through a wire. In yet another embodiment the toolbox may contain a deep cycle battery positioned inside the hollow body, wherein a battery charge is maintained from a fuse box, through the wiring harness. In another embodiment, the tool box embodiment contains a 12 volt DC power outlet. In another embodiment, the toolbox comprises a compressor, wherein the compressor is positioned inside the hollow body.

An embodiment of the toolbox further comprises at least one air hose connector positioned on a wall inside of the toolbox. In yet another embodiment, a first switch may control the light source through communication with the power source and a second switch controls the compressor. In another embodiment, a set of tie-downs may be welded to the surface of the hollow body. In one embodiment, the lid may contain weather stripping positioned around at least one outside edge of the toolbox for weather resistance. Another embodiment of the toolbox lid may include a set of paddle locks for locking the toolbox when the lid is in a closed position.

An embodiment of an accessory kit for modifying a toolbox for use in a pickup truck bed is also disclosed. The kit may include one or more of the following: at least one length of electrical wire for connection to a power source, an in-line fuse for connection between a power supply to an element requiring power, a grommet for protecting the length of electrical wire, a circuit box including fuses, at least one mounting bracket, at least one LED light bar, a plurality of wire connectors, and a plurality of mounting bolts or screws. A further embodiment of the toolbox, wherein the components of the kit are provided together as a single package, has the package further including at least one electrically-operated accessory.

A method for retrofitting a power toolbox into a pickup truck bed is also provided. One embodiment includes the steps of positioning the power toolbox in the pickup truck bed laterally, connecting a wiring harness from a motor vehicle fuse box to a fuse box located on the toolbox, and securing the toolbox in the pickup truck bed with at least one tie-down, located on an outside wall of the toolbox, while tying a securing rope around a truck bed railing. The method may further include connecting the electrical wire between the power source and at least one electrical outlet. The method may further include connecting the electrical wire between the power source and a light source. The meth may further yet include connecting the electrical wire between the power source and a deep cycle battery.

These and other features and characteristics of the device of the present disclosure will become more apparent upon consideration of the following description and the claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the device of the present disclosure. As used in the specification and the claims, the singular form of “a”, “an”, and “the” include plural referents unless the context clearly dictates otherwise.

### BRIEF DESCRIPTION OF THE DRAWINGS

FIG. 1 is a top inside view of an embodiment of a power tool box;

FIG. 2 is a view of a power outlet, including a set of toggle switches connected to the power source and a DC outlet according to the embodiment of FIG. 1;

FIG. 3 is a front view of the power toolbox of FIG. 1;

FIG. 4 is a perspective view of the power toolbox of FIG. 1;

FIG. 5 is a perspective view of the power toolbox in the bed of a pickup truck; and

FIG. 6 is a side view of the power toolbox of FIG. 1.

### DETAILED DESCRIPTION

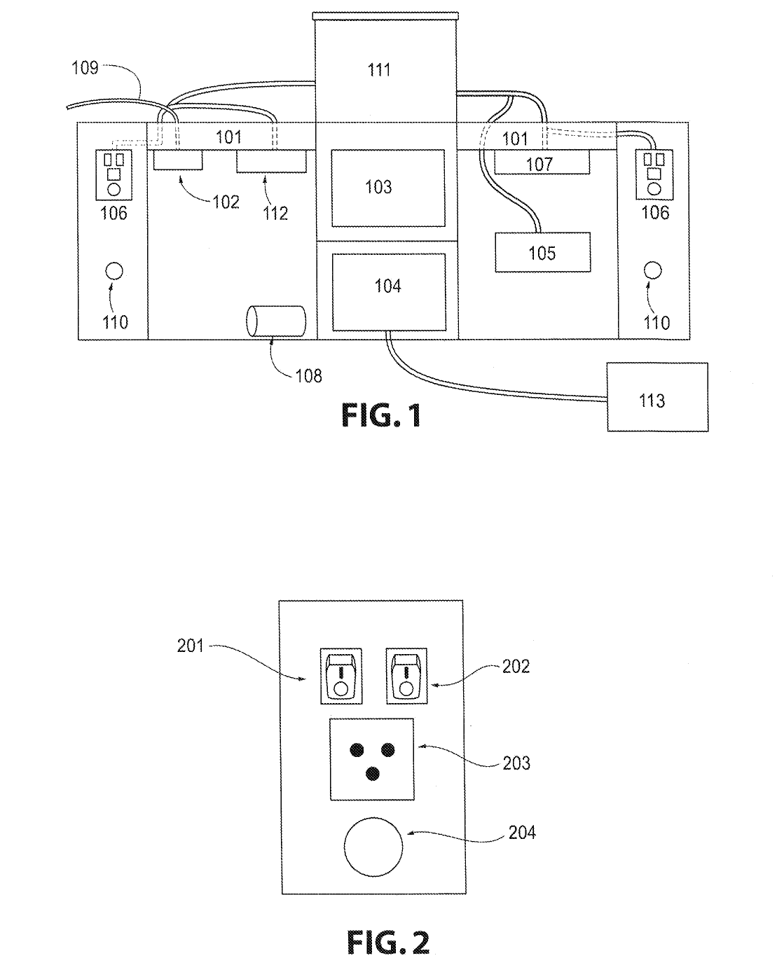

Example of a particular embodiment of a power toolbox, according to the present disclosure, is shown in FIGS. 1-6.

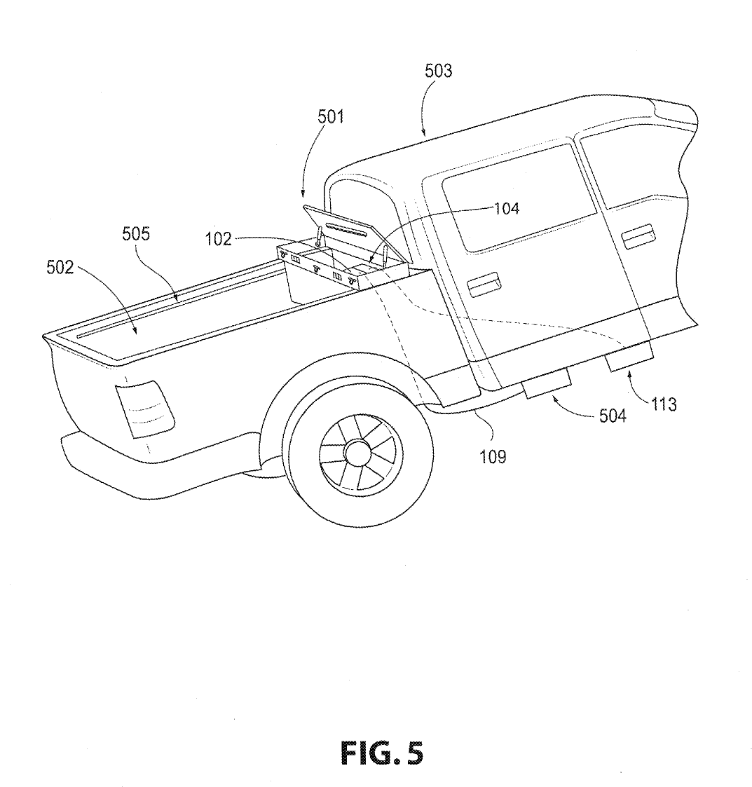

As illustrated in FIG. 1, possible locations for a conduit 101, fuse box 102, battery box 103, power inverter 104, power source 105, power outlet 106, and a light source 107, which may be an auxiliary light source, are noted. The battery box 103 and power invertor 104 may be placed in a separate compartment from the remaining toolbox components, as noted in FIG. 1, with a separate lid 111 to allow for restricted access from the top of the toolbox to the battery box 103 and power invertor 104. The lid 111 can be hinged, as presently depicted, or it can be hinged to open toward the driver side of the box. Another element of the embodiment, a compressor 108, can be mounted near the power inverter 104 for easy access, receiving power from the power source 105 or the power outlet 106. A wiring harness 109 provides power from the truck fuse box 504 to the components of the toolbox, and connects to the fuse box 102 located on the toolbox, originating from the truck body 503, passing under the truck bed 502, through to the toolbox 501, depicted in FIG. 5. An air hose connector 110 may be positioned under the power outlet 106, and located on either side of the power toolbox for easy access. FIG. 1 further depicts the wiring harness 109 passing through the conduit 101, and into the power outlets 106 on either side of the toolbox, to provide a source of power for a variety of plug-in accessories.

An optional deep cycle battery 112 can also be incorporated to prevent excessive drain on the truck's factory battery, as shown in FIG. 1. This could maintain charge through the provided wiring harness 109 from the pickup truck fuse box 504.

An optional accessory could be a compressor, such as a 12 volt compressor, which could have a mount in the toolbox near the power inverter, as shown in FIG. 1. This could also have an air hose attachment 110 near the power outlets on either side of the toolbox so the user could easily access them and allow easier inflation of tires, air-mattresses, toys, etc. The user could also, optionally, utilize an on/off toggle switch 202 to turn the compressor on/off.

FIG. 2 depicts a close up of an outlet from an embodiment of the power toolbox, which includes a power outlet positioned on the power toolbox in a plurality of possible positions. FIG. 2 further depicts the location of a set of on/off toggle switches 201 and 202, for controlling the auxiliary light source 107 and compressor 108 respectively, an AC outlet 203, which may be, for example, a 120 V AC outlet, and a DC outlet 204, which may, for example, be a 12 V DC power outlet. Alternatively, the tog switches could control other aspects of the box and/or truck, such as bed lights.

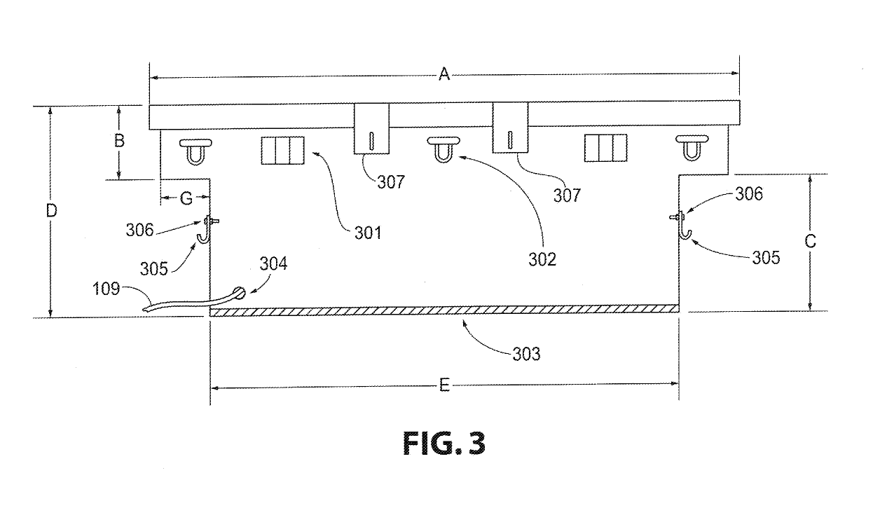

FIG. 3 is a front view of the power toolbox, including the placement according to a specific embodiment of a set of latch locks 301 and yet another feature of an embodiment, the location of a set of tie-downs 302. The tie-downs 302 could, optionally, be incorporated with the toolbox described and depicted herein. Tie-downs 302 could, for example, be integral on an outside wall of the toolbox to allow the use of connecting features, such as bungee cords, ratchet straps, or rope.

Another embodiment of the toolbox depicts a rubberized pad 303 positioned on the base of the toolbox to provide traction during pickup truck motion. FIG. 3 further depicts the location of the wiring harness 109 through a hole in an outside wall of the toolbox, encompassed by a grommet 304, the wiring harness 109 running from the fuse box 102, and passing down under the truck bed 502 and truck body 503.

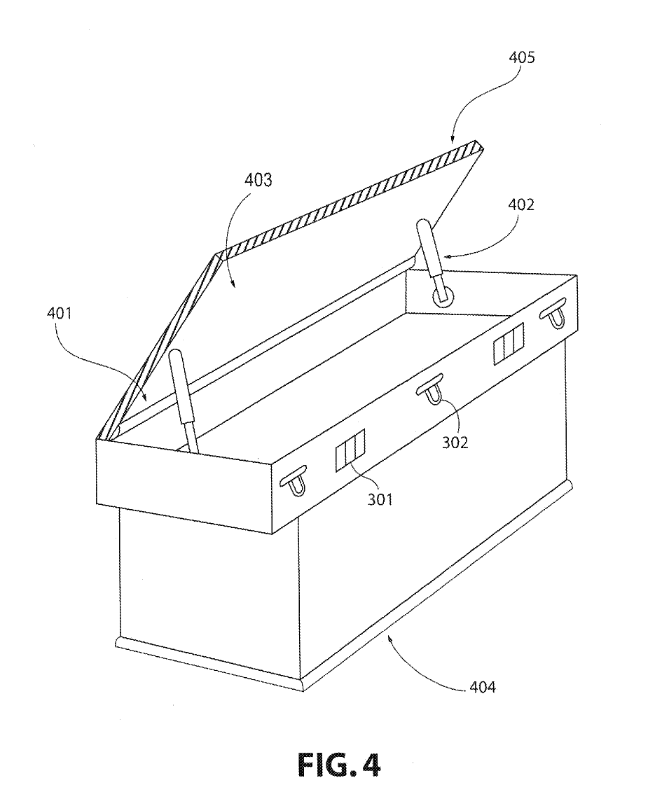

FIG. 4 further depicts an embodiment of the toolbox, in a perspective view with an open lid 403 hinged at the top edge of the toolbox, held in an open position by a set of hydraulic pistons 402. A further embodiment of the toolbox includes a LED light source 401, located on the inside of the toolbox lid 403. The illumination of the LED light source 401 can be associated with the mechanism of opening of the toolbox lid, attached through a hinge mechanism located on the inside of the toolbox lid 403.

The LED light bar 401 is attached to the inside of the toolbox lid 403 and may be located close to the lid hinge, for example. It could also be low profile so as to not limit storage space. The illumination of this light could provide light to both the toolbox and the bed of the truck when the toolbox is open.

FIG. 5 shows a particular embodiment, with the toolbox 501 positioned in the bed of the pickup truck 502. The figure further depicts the truck body 503, and the wiring harness running from the truck fuse box 504, under the truck body 503, under the truck bed 502, running horizontally up through the truck bed, and finally to the fuse box 102 of the toolbox 501.

In further examples, a toolbox could be made of diamond plate aluminum and welded together at the seams. A lid 403, such as shown in FIG. 4, could be available as a single hinge cross-box type, and could include paddle locks 307. As a further example, the toolbox could include a single full width hinge for a cross-box type lid and two latch locks 301.

The lid, for example, could have weather stripping 405 along the edges to make it weather resistant. There may also be tie-downs 302 welded to the main body of the toolbox and an outside wall of the toolbox. The toolbox could also, optionally, be secured to the truck bed rails 505 with “J hooks” 305, held in place with a washer and nut 306. Bed rail protectors could also optionally be provided. Further, additional power outlets and fuses/circuitry could be included in the toolbox.

The wiring harness 109 could, optionally, be provided for the user of the toolbox to install which could be connected from the motor vehicle toolbox 504 to the toolbox fuse box 102, as shown in FIG. 1 and FIG. 5. The toolbox may have a fuse associated with it to prevent electrical overload to the system, and may include, for example, a 10 gauge primary wire. The wiring harness 109 could then pass through a grommet 304 to prevent rubbing of the wire on bare metal. It could then subsequently enter the toolbox where there may be a panel dedicated to each circuit requiring power. Examples of features that may require a separate circuit include auxiliary lights, power inverters, power outlets, and compressors. Each of the circuits associated with each of these features may have its own associated fuse as well.

Similarly an accessory light 404 could, optionally, be installed under the bottom of the box, which may allow illumination of the truck bed at night, or when a tonneau and/or hard-cover is installed in the truck bed. The accessory light 404 may be controlled by one of the embodiments of the on/off toggle switches 201 or 202, located inside and on either side of the toolbox.

The power inverter takes the DC power generated by the pickup truck alternator 113, stores the DC power in the battery, and then converts it to AC power. AC power can then be used to charge batteries, run accessories, extra lights, computers, and small power tools, for example. The power inverter 104 that may be included in a toolbox, according to the present disclosure, could, optionally, be mounted in the center of the toolbox to minimize disruption of the accessible storage space which is usually closer to the outer margins of the toolbox. The power inverter may be protected by a separate lid 111 to prevent damage.

In other embodiments, a toolbox could, for example, be manufactured to fit full-size pickup trucks available from various pickup truck manufacturers, such as Ford, Chevy, Dodge, Toyota, and Nissan, as shown in FIG. 5. Any desirable dimensions could be used, such as the dimensions required to fit the specific model of pickup truck for which the toolbox will be used, such as those from the manufacturers mentioned above.

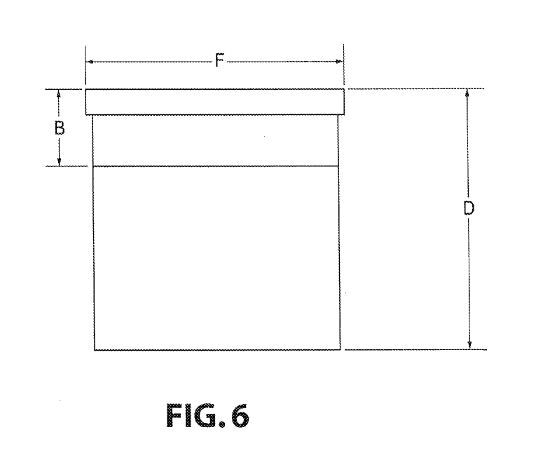

In one non-limiting embodiment, the toolbox has dimensions corresponding to those represented in FIG. 3 and FIG. 6. Dimension A corresponds to the width of the pickup truck bed, and may be 70 inches. Dimension B represents the height of the toolbox above the pickup truck bed rail and may be 3 inches. Dimension C corresponds to the depth of the toolbox below the pickup truck bed rail to the base of the toolbox from the top of the lid to the base of the toolbox and may be 20 inches. Dimension D corresponds to the preferred total height of the toolbox and may be 23 inches. Dimension E corresponds to the width of the base of the toolbox in the pickup truck bed and may be 62 inches. Dimension G corresponds to the width of the toolbox over the pickup truck rail and may be 4 inches. FIG. 4 shows a side view of the toolbox and the dimensions corresponding to dimensions B and D, as well as dimension F, which may be 20 inches, and which corresponds to the length from the front of the toolbox to the back of the toolbox when positioned in the pickup truck bed.

A further aspect of the current embodiment, is a kit for providing additional functionality to a toolbox, such as by retrofitting the toolbox to a pickup truck.

Another embodiment is a kit may include some or all of the following components to be added or removed from the toolbox, depending on the user's needs:
A 20′ length of 10 gauge wire;
A 20′ 16 gauge wire;
A 20 amp in-line fuse;
A grommet for through-wire protection;
A circuit box with a set of integral 10 amp fuses;
A set of toggle switches for controlling the turning on/off of various toolbox components;
A 12 volt power outlet for powering compatible electronic accessories;
A plurality of mounting brackets;
A set of LED light bars for placement on the underside of the toolbox lid;
A plurality of wire connectors;
A plurality of external tie-downs; and
A plurality of hardware/mounting bolts and screws.

The components of the kit, may be incorporated into the toolbox to retrofit it to a vehicle, such as a pickup truck, by incorporating the components, described above, in the orientations and positions described and illustrated herein. In one embodiment, the kit may include at least one instruction manual comprising instructions informing a user how to modify an existing toolbox to incorporate additional functionality. The instructions may further include templates to show preferred placements for the functional components. In a preferred, non-limiting embodiment, at least a portion of the instructions and/or templates may be customized to facilitate the use of the kit with an existing truck and/or toolbox of known or pre-determined design.

In another embodiment, the components of the kit are provided together in a single package.

In a further non-limiting embodiment, the kit may further include at least one electrically-operated accessory, such as, for example, an air compressor, a power tool, a battery charger, or any combination thereof.

In a further aspect, a method for retrofitting the power toolbox into a pickup truck is provided, which may include positioning the power toolbox in the pickup truck bed laterally. Once placed in the truck bed, the toolbox connects to an electrical wire through the wiring harness, from the pickup truck fuse box to the toolbox fuse box. The connection provides power to the power source, the set of electrical outlets, the lighting sources, and the deep cycle battery. The steps of providing the above-described components, in the positions and orientations described herein, can also be included in the method.

Although the present invention has been described in detail in connection with exemplary embodiments, as described above and shown in the attached Figures, it is to be understood that such detail is solely for the purpose of being illustrative of the aspects of the present disclosure and that variations can be made by those skilled in the art without departing from the spirit of the invention.

While specific embodiments have been described in detail herein, it will be appreciated by those skilled in the art that various modifications and alternatives to those details could be developed in light of the overall teachings of the disclosure. Accordingly, the particular arrangements disclosed are meant to be illustrative only and not limiting as to the scope of the devices, systems, and methods of the present disclosure which is to be given the full breadth of the claims appended and any and all equivalents thereof.

The invention claimed is:

1. A toolbox for use in a pickup truck bed, comprising:
a hollow body, comprising a top, a bottom, and a plurality of walls;
a first lid, wherein the first lid is attached to an outside edge of the top of the hollow body;
a connection for a power source positioned inside the hollow body, located on at least one of the plurality of walls;
at least one electrical outlet positioned on a surface of the hollow body; and
at least one light source, wherein the light source is positioned inside the hollow body and is connected to the power source.

2. The toolbox of claim 1, further comprising a second lid, wherein the second lid is attached to an inside edge of the top of the hollow body.

3. The toolbox of claim 1, further comprising a rubberized pad positioned on the bottom of the hollow body.

4. The toolbox of claim 1, further comprising a wiring harness connected to a motor vehicle fuse box, wherein the wiring harness passes under a pickup truck body laterally to the pickup truck bed, and then horizontally traveling through the truck bed, through a drill hole located in the back of the toolbox, through a conduit positioned inside the hollow body, and connecting to a toolbox fuse box positioned inside the hollow body.

5. The toolbox of claim 1, further comprising a power inverter positioned inside the hollow body, wherein the power inverter converts DC power to AC power and receives power from a motor vehicle alternator, through a wire.

6. The toolbox of claim 1, further comprising a deep cycle battery positioned inside the hollow body, wherein a battery charge is maintained from a toolbox fuse box, through a wiring harness.

7. The toolbox of claim 1, further comprising a 12 volt DC power outlet.

8. The toolbox of claim 1, further comprising a compressor, wherein the compressor is positioned inside the hollow body.

9. The toolbox of claim 1, further comprising at least one air hose connector positioned on an inside wall of the toolbox.

10. The toolbox of claim 1, wherein a first switch controls the light source through communication with the power source and a second switch controls the compressor.

11. The toolbox of claim 1, wherein a set of tie-downs are welded to the surface of the hollow body.

12. The toolbox of claim 1, wherein the lid includes weather stripping positioned around at least one outside edge for weather resistance.

13. The toolbox of claim 1, wherein the lid includes a set of paddle locks for locking the toolbox when the lid is in a closed position.

14. An accessory kit for modifying a toolbox for use in a pickup truck bed, comprising:
at least one length of electrical wire for connection to a power source;
an in-line fuse for connection between a power supply to an element requiring power;
a grommet for protecting the length of electrical wire;
a circuit box comprising fuses;
at least one mounting bracket;
at least one LED light bar;
a plurality of wire connectors; and
a plurality of mounting bolts or screws.

15. The accessory kit of claim 14, wherein components of the kit are provided together as a single package, the package further comprising at least one electrically-operated accessory.

16. A method for retrofitting a power toolbox into a pickup truck bed, comprising:
positioning the power toolbox in the pickup truck bed;
connecting a wiring harness from a motor vehicle fuse box to a fuse box located on the toolbox; and
securing the toolbox in the pickup truck bed with at least one tie-down, located on an outside wall of the toolbox, and tying a securing rope around a truck bed railing.

17. The method of claim 16, further comprising connecting electrical wire between a power source and at least one electrical outlet.

18. The method of claim 16, further comprising connecting electrical wire between a power source and a light source.

19. The method of claim 16, further comprising connecting electrical wire between a power source and a deep cycle battery.
